(19) United States
(12) Patent Application Publication
(10) Pub. No.: US 2026/0214290 A1
(43) Pub. Date: Jul. 23, 2026

(54) IN-VEHICLE APPARATUS, VEHICLE, NON-TRANSITORY STORAGE MEDIUM, AND AGE RESTRICTION APPLICATION METHOD

(71) Applicant: TOYOTA JIDOSHA KABUSHIKI KAISHA, Toyota-shi (JP)

(72) Inventor: Takashi HATTORI, Kasugai-shi (JP)

(73) Assignee: TOYOTA JIDOSHA KABUSHIKI KAISHA, Toyota-shi (JP)

(21) Appl. No.: 19/442,505

(22) Filed: Jan. 7, 2026

(30) Foreign Application Priority Data
Jan. 21, 2025 (JP) 2025-008547

(51) Int. Cl. H04N 21/414; B60K 35/10; H04N 21/441; H04N 21/45

(52) U.S. Cl. CPC H04N 21/41422; B60K 35/10; H04N 21/441; H04N 21/4532; B60K 2360/731

(57) ABSTRACT

An in-vehicle apparatus installed in a vehicle includes a communication unit configured to communicate with a server apparatus configured to provide a plurality of content distribution services, and a control unit configured to, in response to receiving user input to set an age restriction, apply the set age restriction regardless of which content distribution service is used when one of the content distribution services is used via the communication unit.

### CROSS-REFERENCE TO RELATED APPLICATION

This application claims priority to Japanese Patent Application No. 2025-008547 filed on January 21, 2025. The disclosure of the above-identified application, including the specification, drawings, and claims, is incorporated by reference herein in its entirety.

### BACKGROUND

### 1. Technical Field

The disclosure relates to an in-vehicle apparatus, a vehicle, a non-transitory storage medium, and an age restriction application method.

### 2. Description of Related Art

Japanese Unexamined Patent Application Publication No. 2018-153624 (JP 2018-153624 A) describes a server apparatus that extracts videos with age restrictions from a group of distributable videos as associated videos and restricts the distribution of the associated videos.

### SUMMARY

When a user uses a video streaming service on an IVI terminal, the user may want to restrict viewable content while driving with a child. “IVI” is an abbreviation for in-vehicle infotainment. Generally, each content provider offering a video streaming service provides its own UI for setting an age restriction. However, if those UIs are directly applied to IVI terminals, each service needs individual settings, so the convenience of users reduces. “UI” is an abbreviation for user interface.

The disclosure provides a technology that enables collective setting of an age restriction for a plurality of content distribution services used in a vehicle.

A first aspect of the disclosure is an in-vehicle apparatus installed in a vehicle. The in-vehicle apparatus includes a storage unit, a communication unit configured to communicate with a server apparatus configured to provide a plurality of content distribution services, and a control unit. The control unit is configured to, when the control unit receives user input to set an age restriction via an input device mounted on the vehicle, store the set age restriction in the storage unit. The control unit is configured to, during a period from when accessory power of the vehicle is turned on until the accessory power is turned off, determine whether an exemption condition is satisfied, using a sensor mounted on the vehicle. The control unit is configured to, in response to receiving user input to select one of the content distribution services via the input device, receive a list including content not subject to the age restriction stored in the storage unit, via the communication unit from the server apparatus configured to provide the selected content distribution service when the control unit determines that the exemption condition is not satisfied, and receive a list including other content in addition to the content not subject to the age restriction when the control unit determines that the exemption condition is satisfied. The control unit is configured to output the received list via an output device mounted on the vehicle. The control unit is configured to, in response to receiving user input to select one of pieces of content included in the list via the input device, receive the selected piece of content via the communication unit from the server apparatus configured to provide the selected content distribution service. The control unit is configured to output the received piece of content via the output device.

A second aspect of the disclosure is an in-vehicle apparatus installed in a vehicle. The in-vehicle apparatus includes a communication unit configured to communicate with a server apparatus configured to provide a plurality of content distribution services, and a control unit configured to, in response to receiving user input to set an age restriction, apply the set age restriction regardless of which content distribution service is used when one of the content distribution services is used via the communication unit.

In the second aspect, the control unit may be configured to, in response to receiving user input to select one of the content distribution services, receive a list of only content not subject to the age restriction, via the communication unit from the server apparatus configured to provide the selected content distribution service, and output the received list via an output device mounted on the vehicle.

In the second aspect, the control unit may be configured to, in response to receiving user input to select one of pieces of content included in the list, receive the selected content via the communication unit from the server apparatus configured to provide the selected content distribution service, and output the received piece of content via the output device.

In the second aspect, the control unit may be configured to not apply the age restriction when the control unit determines that an exemption condition is satisfied, and one of the content distribution services is used regardless of which content distribution service is used.

In the second aspect, the control unit may be configured to output a subsequent portion of the same content via an output device mounted on the vehicle when the same content distribution service is used with the age restriction applied, and previously output content is content not subject to the age restriction after one of the content distribution services is used without applying the age restriction, and not output the subsequent portion when the previously output content is not content not subject to the age restriction.

In the second aspect, the control unit may be configured to, when the previously output content is not content not subject to the age restriction, output a list of content not subject to the age restriction, via the output device.

In the second aspect, the exemption condition may include a condition that no occupant is present in any seat, other than a driver seat, of the vehicle. The control unit may be configured to determine whether an occupant is present in any seat, other than the driver seat, using a sensor mounted on the vehicle.

In the second aspect, the exemption condition may include a condition that no child is present in the vehicle. The control unit may be configured to determine whether a child is present in the vehicle, using a sensor mounted on the vehicle.

In the second aspect, the exemption condition may include a condition that no occupant below the age restriction is present in the vehicle. The control unit may be configured to determine whether an occupant below the age restriction is present in the vehicle, using a sensor mounted on the vehicle.

In the second aspect, the exemption condition may include a condition that no occupant registered as being subject to the age restriction is present in the vehicle. The control unit may be configured to determine whether an occupant registered as being subject to the age restriction is present in the vehicle, using a sensor mounted on the vehicle.

In the second aspect, the exemption condition may include a condition that a user does not consent to application of the age restriction. The control unit may be configured to, before one of the content distribution services is used, confirm with the user whether to consent to application of the age restriction, using an input device and an output device mounted on the vehicle.

In the second aspect, the control unit may be configured to, in response to receiving user input to set the age restriction along with user input to apply the age restriction without confirmation, apply the age restriction when one of the content distribution services is used without confirming with the user whether to consent to application of the age restriction.

In the second aspect, the exemption condition may include a condition that a user selects not to apply the age restriction. The control unit may be configured to receive user input to set the age restriction along with user input to select not to apply the age restriction.

In the second aspect, the control unit may be configured to, during a period from when accessory power of the vehicle is turned on until the accessory power is turned off, determine whether the exemption condition is satisfied.

In the second aspect, the control unit may be configured to estimate an age of an occupant in the vehicle. The control unit may be configured to, instead of receiving user input to set the age restriction, automatically set the age restriction based on the estimated age.

In the second aspect, the content distribution services may include a video streaming service.

A third aspect of the disclosure is a vehicle that includes the in-vehicle apparatus.

A fourth aspect of this disclosure is an age restriction application method. The age restriction application method includes applying an age restriction regardless of which content distribution service is used regardless of which content distribution service is used when an in-vehicle apparatus configured to communicate with one or more server apparatuses configured to provide a plurality of content distribution services receives user input to set the age restriction, and one of the plurality of content distribution services is used.

A fifth aspect of the disclosure is a non-transitory storage medium storing instructions executable on one or more processors and causing the one or more processors to execute the age restriction application method.

According to the first, second, third, fourth, and fifth aspects of the disclosure, it is possible to collectively set an age restriction for a plurality of content distribution services used in a vehicle. As a result, the convenience of a user improves.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows the configuration of a system according to an embodiment of the disclosure;

FIG. 2 is a block diagram that shows the configuration of an in-vehicle apparatus according to the embodiment of the disclosure and connection of the in-vehicle apparatus to various devices mounted on a vehicle;

FIG. 3 is a flowchart that shows the operation of the in-vehicle apparatus according to the embodiment of the disclosure;

FIG. 4 is a sequence diagram that shows a series of interactions of the in-vehicle apparatus according to the embodiment of the disclosure with a user;

FIG. 5 is a sequence diagram that shows a series of interactions of the in-vehicle apparatus according to the embodiment of the disclosure with a user and a server apparatus; and

FIG. 6 is a sequence diagram that shows a series of interactions of the in-vehicle apparatus according to the embodiment of the disclosure with a user and a server apparatus.

### DETAILED DESCRIPTION OF EMBODIMENTS

Hereinafter, an embodiment of the disclosure will be described with reference to the accompanying drawings.

Like reference signs denote the same or corresponding portions in the drawings. In the description of the present embodiment, the description of the same or corresponding portions is omitted or simplified as needed.

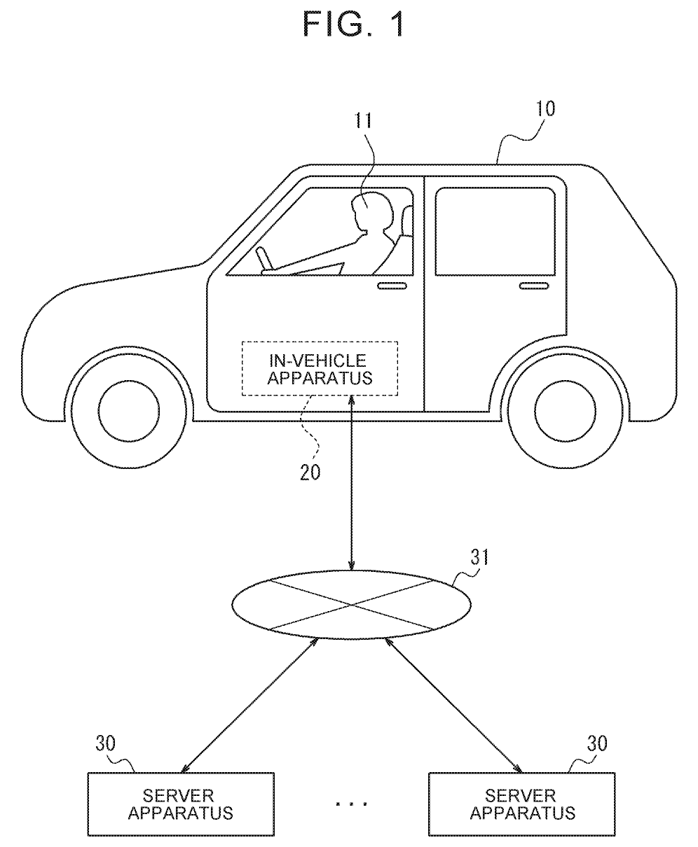

The configuration of a system according to the present embodiment will be described with reference to FIG. 1.

The system according to the present embodiment includes an in-vehicle apparatus 20 installed in a vehicle 10 and one or more server apparatuses 30 that provide a plurality of content distribution services. The in-vehicle apparatus 20 is capable of communicating with the server apparatuses 30 via a network 31.

The vehicle 10 is any type of vehicle, such as a gasoline vehicle, a diesel vehicle, a hydrogen vehicle, an HEV, a PHEV, a BEV, and an FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The vehicle 10 is driven by a user 11 in the present embodiment. Alternatively, the vehicle 10 may be automatically driven at a selected level. The level of automation is, for example, any one of level 1 to level 5 in SAE-defined levels. “SAE” is an abbreviation for Society of Automotive Engineers. The vehicle 10 may be a MaaS-dedicated vehicle. “MaaS” is an abbreviation for Mobility as a Service.

The in-vehicle apparatus 20 is a computer, such as a microcomputer and ECU, mounted on the vehicle 10. “ECU” is an abbreviation for electronic control unit.

The server apparatus 30 is a computer, such as a cloud server, installed in a facility, such as a data center. In the present embodiment, the number of server apparatuses 30 is two or more, and each server apparatus 30 provides at least one content distribution service. In other words, two or more server apparatuses 30 provide a plurality of content distribution services as a whole system. In a modification, the number of server apparatuses 30 may be one; however, in such a modification, a single server apparatus 30 provides a plurality of content distribution services.

In the present embodiment, a plurality of content distribution services includes one or more video streaming services. For example, a plurality of content distribution services may be a plurality of OTTs. “OTT” is an abbreviation for over-the-top media service. A plurality of content distribution services all may be video streaming services or may include services that distribute content other than video, such as music. In a modification, a plurality of content distribution services all may be services that distribute content other than video.

The network 31 includes the Internet, at least one WAN, at least one MAN, or any combination of them. “WAN” is an abbreviation for wide area network. “MAN” is an abbreviation for metropolitan area network. The network 31 may include at least one wireless network, at least one optical network, or any combination of them. Examples of the wireless network include an ad hoc network, a cellular network, a wireless LAN, a satellite communication network, and a terrestrial microwave network. “LAN” is an abbreviation for local area network.

The outline of the present embodiment will be described with reference to FIG. 1.

When the in-vehicle apparatus 20 receives user input to set an age restriction, the in-vehicle apparatus 20 applies the set age restriction when any one of the plurality of content distribution services, provided by the server apparatuses 30, is used regardless of which content distribution service is used. Therefore, according to the present embodiment, it is possible to collectively set an age restriction for a plurality of content distribution services. As a result, the convenience of the user 11 improves.

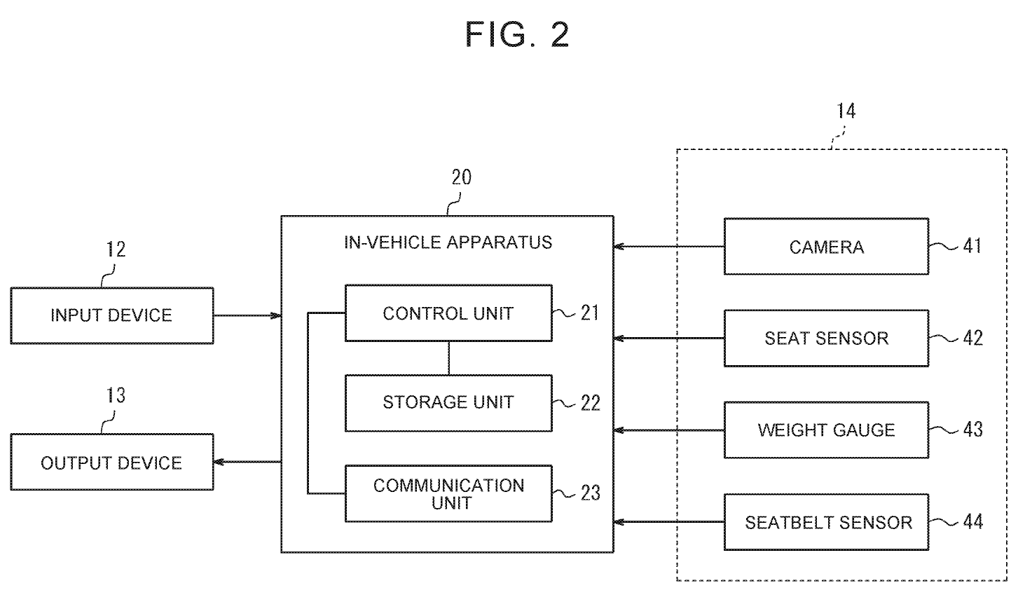

As shown in FIG. 2, in the present embodiment, the in-vehicle apparatus 20 is connected to various devices such as an input device 12, an output device 13, and a sensor 14, mounted on the vehicle 10.

The input device 12 is, for example, a physical key, a capacitance key, a pointing device, a touch screen provided integrally with a display, or a microphone.

The output device 13 is, for example, a display or a speaker. The display is, for example, an LCD or an organic EL display. “LCD” is an abbreviation for liquid crystal display. "EL" is an abbreviation for electro luminescent. The display may also be a display audio.

The sensor 14 is, for example, a camera 41, a seat sensor 42, a weight gauge 43, a seatbelt sensor 44, or any combination of them. The camera 41 is installed at a position where the camera 41 is capable of capturing images of seats, other than the driver seat, of the vehicle 10. The seat sensor 42, the weight gauge 43, and the seatbelt sensor 44 are also installed at least at the seats other than the driver seat. The camera 41, the seat sensor 42, the weight gauge 43, or the seatbelt sensor 44 is used to determine whether an occupant is present in any seat, other than the driver seat, of the vehicle 10. When an occupant is present in any seat other than the driver seat, the camera 41 may be used to determine how old the occupant is and who the occupant is. As a method of determination, a technique, such as image recognition using machine learning, can be used. The camera 41 may also serve as the input device 12.

Interfaces that support standards, such as USB, HDMI (registered trademark), and Bluetooth (registered trademark), can be used as the interfaces of the in-vehicle apparatus 20 for connecting to various devices mounted on the vehicle 10. “USB” is an abbreviation for Universal Serial Bus. “HDMI (registered trademark)” is an abbreviation for High-Definition Multimedia Interface. The in-vehicle apparatus 20 may be connected to various devices mounted on the vehicle 10 via an in-vehicle network, such as CAN. “CAN” is an abbreviation for Controller Area Network. In a modification, the in-vehicle apparatus 20 may include one or more of the various devices mounted on the vehicle 10.

The configuration of the in-vehicle apparatus 20 according to the present embodiment will be described with reference to FIG. 2.

The in-vehicle apparatus 20 includes a control unit 21, a storage unit 22, and a communication unit 23.

The control unit 21 includes at least one processor, at least one programmable circuit, at least one dedicated circuit, or any combination of them. The processor is, for example, a general-purpose processor, such as a CPU and a GPU, or a special-purpose processor specialized in a specific process. “CPU” is an abbreviation for central processing unit. “GPU” is an abbreviation for graphics processing unit. The programmable circuit is, for example, an FPGA. “FPGA” is an abbreviation for field-programmable gate array. The dedicated circuit is, for example, an ASIC. "ASIC" is an abbreviation for application specific integrated circuit. The control unit 21 executes a process related to the operation of the in-vehicle apparatus 20 while controlling the units of the in-vehicle apparatus 20.

The storage unit 22 includes at least one semiconductor memory, at least one magnetic memory, at least one optical memory, or any combination of them. The semiconductor memory is, for example, a RAM, a ROM, or a flash memory. “RAM” is an abbreviation for random access memory. “ROM” is an abbreviation for read only memory. The RAM is, for example, an SRAM or a DRAM. “SRAM” is an abbreviation for static random access memory. “DRAM” is an abbreviation for dynamic random access memory. The ROM is, for example, an EEPROM. “EEPROM” is an abbreviation for electrically erasable programmable read only memory. The flash memory is, for example, an SSD. “SSD” is an abbreviation for solid-state drive. The magnetic memory is, for example, an HDD. “HDD” is an abbreviation for hard disk drive. The storage unit 22 functions as, for example, a main storage device, an auxiliary storage device, or a cache memory. The storage unit 22 stores information used in the operation of the in-vehicle apparatus 20 and information obtained through the operation of the in-vehicle apparatus 20.

The communication unit 23 includes at least one communication module. The communication module is, for example, a module that supports a mobile communication standard, such as LTE, 4G standard, and 5G standard, or a wireless LAN communication standard, such as IEEE 802.11. “LTE” is an abbreviation for Long Term Evolution. “4G” is an abbreviation for 4th generation. “5G” is an abbreviation for 5th generation. “IEEE” is an abbreviation for Institute of Electrical and Electronics Engineers. The communication unit 23 communicates with the server apparatuses 30. The communication unit 23 receives information used in the operation of the in-vehicle apparatus 20 and transmits information obtained through the operation of the in-vehicle apparatus 20.

The functions of the in-vehicle apparatus 20 are implemented by the processor, that is, the control unit 21, running a program according to the present embodiment. In other words, the functions of the in-vehicle apparatus 20 are implemented by software. The program causes a computer to function as the in-vehicle apparatus 20 by causing the computer to execute the operation of the in-vehicle apparatus 20. In other words, the computer executes the operation of the in-vehicle apparatus 20 in accordance with the program to function as the in-vehicle apparatus 20.

The program can be stored in a non-transitory computer-readable medium. The non-transitory computer-readable medium is, for example, a flash memory, a magnetic recording device, an optical disc, a magneto-optical recording medium, or a ROM. The program is distributed by, for example, selling, transferring, or lending a portable medium, such as an SD card, a DVD, and a CD-ROM, in which the program is stored. "SD" is an abbreviation for Secure Digital. “DVD” is an abbreviation for digital versatile disc. "CD- ROM" is an abbreviation for compact disc read only memory. Alternatively, the program may be distributed by storing the program in a storage of a server and transferring the program from the server to another computer. Alternatively, the program may be provided as a program product.

A computer, for example, once stores a program, stored in a portable medium or transferred from a server, in a main storage device. Then, the computer causes a processor to read the program stored in the main storage device and executes a process according to the read program on the processor. The computer may directly read the program from the portable medium and execute a process according to the program. Each time the program is transferred from a server to the computer, the computer may occasionally execute a process according to the received program. The program may be executed by a so-called ASP service in which the program is not transferred from a server to the computer and a function is implemented only by providing an execution instruction and acquiring a result. “ASP” is an abbreviation for application service provider. The program includes information subjected to a process on an electronic computer and similar to a program. For example, data that is not a direct command to a computer and that has a property of defining a process of the computer corresponds to “information similar to a program”.

One or some or all of the functions of the in-vehicle apparatus 20 may be implemented by a programmable circuit or a dedicated circuit serving as the control unit 21. In other words, one or some or all of the functions of the in-vehicle apparatus 20 may be implemented by hardware.

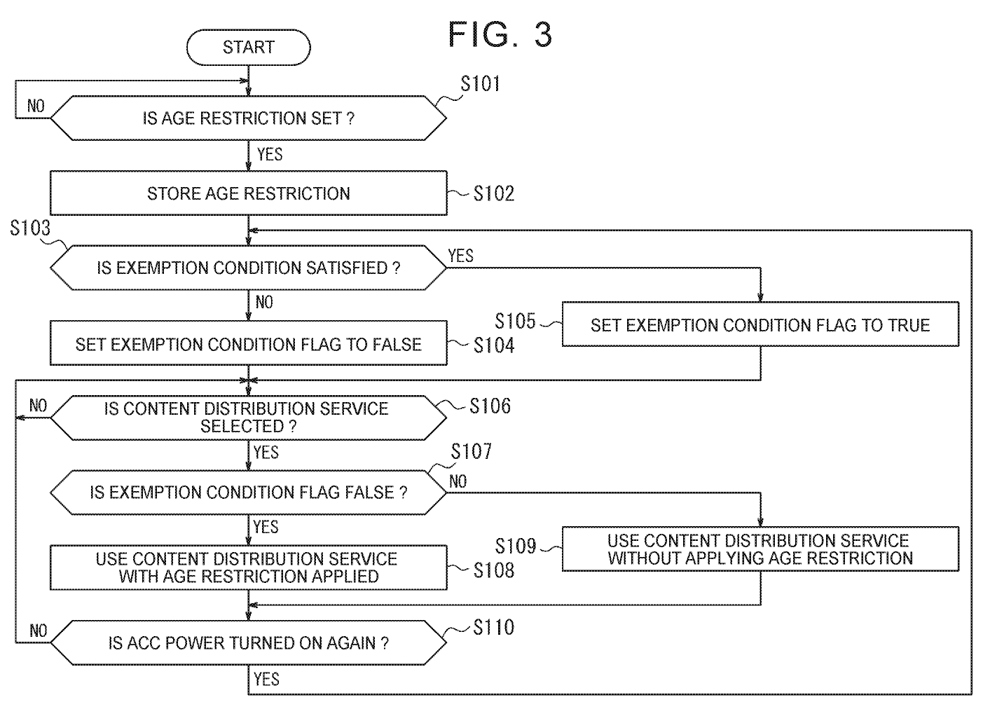

The operation of the in-vehicle apparatus 20 according to the present embodiment will be described with reference to FIG. 3. The operation described below is an example of an age restriction application method according to the present embodiment. In other words, the age restriction application method according to the present embodiment includes S101, S102, S103, S104, S105, S106, S107, S108, S109, and S110 shown in FIG. 3.

When the control unit 21 receives user input to set an age restriction via the input device 12 in S101, the control unit 21 stores the set age restriction in the storage unit 22 in S102.

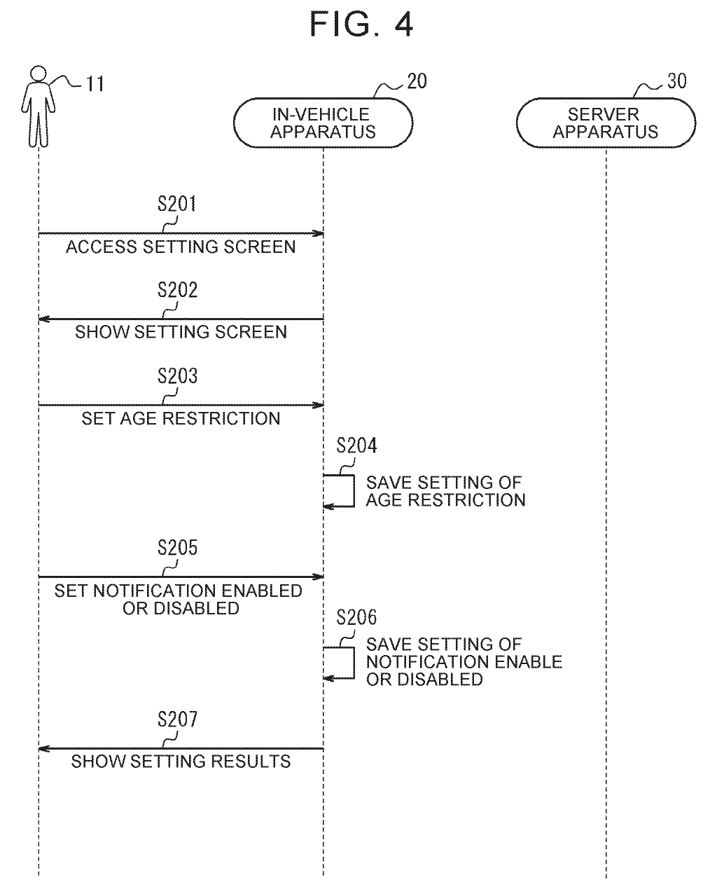

For example, as shown in FIG. 4, the user 11 can access a setting screen in S201. The control unit 21 causes the display to show the setting screen in S202. The user 11 can touch the setting screen to set the age of a child, such as "10 years old”, as an age restriction in S203. Instead of the age itself, the range of age, such as “12 years old or under”, may be set as an age restriction. Alternatively, the user 11 may be able to set an age restriction using voice. When the control unit 21 receives the setting of an age restriction via the touch screen or the microphone, the control unit 21 saves the setting of the age restriction in a non-volatile memory, such as a flash memory, in S204.

The control unit 21 may estimate the age of an occupant in the vehicle 10 using the camera 41. As a method of estimation, a technique, such as image recognition using machine learning, can be used. The control unit 21 may suggest the setting of an age restriction to the user 11 based on the obtained estimated age. Alternatively, the control unit 21 may automatically set an age restriction based on the obtained estimated age instead of receiving user input to set an age restriction.

In an example, when the control unit 21 detects a 10-year-old child using the camera 41, the control unit 21 suggests to the user 11 that the age restriction be set to "10 years old" or "12 years old or under" via the display or the speaker. When the control unit 21 detects an eight-year-old child in addition to a 10-year-old child, the control unit 21 may suggest to the user 11 that the age restriction be set to “eight years old" or “nine years old or under" lower by one level than “12 years old or under” in accordance with a lower age. The user 11 can set an age restriction by consenting to the suggestion through touching the screen or voice. Alternatively, the user 11 may set an age restriction by adjusting the suggested setting as needed through touching the screen or using voice. In another example, when the control unit 21 detects a 10-year-old child using the camera 41, the control unit 21 automatically sets the age restriction to "10 years old" or "12 years old or under”. When the control unit 21 detects an eight-year-old child in addition to a 10-year-old child, the control unit 21 may automatically set the age restriction to “eight years old" or “nine years old or under” in accordance with a lower age. The user 11 may change the automatically set setting as needed by touching the screen or using voice.

The control unit 21 determines whether an exemption condition is satisfied in S103 at least once during each period from when accessory power of the vehicle 10 is turned on until the accessory power is turned off. When the control unit 21 determines that the exemption condition is not satisfied, the control unit 21 sets an exemption condition flag to False in S104. On the other hand, when the control unit 21 determines that the exemption condition is satisfied, the control unit 21 sets the exemption condition flag to True in S105.

In a first example, the exemption condition includes a condition that no occupant is present in any seat, other than the driver seat, of the vehicle 10. The control unit 21 determines whether an occupant is present in any seat, other than the driver seat, of the vehicle 10, using the sensor 14 such as the camera 41, the seat sensor 42, the weight gauge 43, and the seatbelt sensor 44.

In a second example, the exemption condition includes a condition that no child is present in the vehicle 10. The control unit 21 determines whether a child is present in the vehicle 10, using the sensor 14 such as the camera 41.

In a third example, the exemption condition includes a condition that no occupant below the age restriction is present in the vehicle 10. The control unit 21 reads the age restriction from the storage unit 22. The control unit 21 determines whether an occupant below the age restriction is present in the vehicle 10, using the sensor 14 such as the camera 41.

In a fourth example, the exemption condition includes a condition that no occupant registered as being subject to the age restriction is present in the vehicle 10. The control unit 21 determines whether an occupant registered as being subject to the age restriction is present in the vehicle 10, using the sensor 14 such as the camera 41.

For example, the user 11 is able to access a camera control screen when a child is present in the vehicle 10. The control unit 21 causes the display to show the camera control screen before S103. The user 11 is able to operate the camera 41 so that the camera 41 captures a facial image of a child, by touching the camera control screen. When the control unit 21 receives operation of the camera 41 via the touch screen, the control unit 21 saves the facial image captured by the camera 41 in a non-volatile memory. In S103, the control unit 21 uses the camera 41 to capture a facial image of an occupant in the vehicle 10 and determines whether any occupant in the vehicle 10 matches the facial image saved in the non-volatile memory.

In a fifth example, the exemption condition includes a condition that the user 11 does not consent to application of the age restriction. The control unit 21 confirms with the user 11 whether to consent to application of the age restriction using the input device 12 and the output device 13 before any one of the plurality of content distribution services is used.

For example, the user 11 is able to access a confirmation screen. The control unit 21 causes the display to show the confirmation screen. Alternatively, the control unit 21 may cause the speaker to output a question, for example, "Do you consent to application of the age restriction?”. The user 11 is able to select any one of consent and refusal for application of the age restriction by touching the confirmation screen or using voice. When the control unit 21 receives the selection of consent via the touch screen or the microphone, the control unit 21 determines that the user 11 has consented to application of the age restriction. When the control unit 21 receives the selection of refusal via the touch screen or the microphone, the control unit 21 determines that the user 11 has not consented to application of the age restriction.

The control unit 21 may receive user input to set an age restriction along with user input to select application of the age restriction without confirmation.

For example, as shown in FIG. 4, the user 11 may be able to enable or disable notifications, such as displaying the confirmation screen and outputting questions, in S205. In such cases, the control unit 21 saves any one of notification enabled and notification disabled in the non-volatile memory in S206. In S207, the control unit 21 causes the display to show a result report indicating that the setting of the age restriction and the setting of notification enabled or disabled have been completed. Alternatively, the control unit 21 may cause the speaker to output the result report.

In a sixth example, the exemption condition includes a condition that the user 11 has selected not to apply the age restriction. The control unit 21 can receive user input to set an age restriction along with user input to select not to apply the age restriction in S101.

For example, in S203, the user 11 can set an age restriction by touching the setting screen or using voice and can select any one of enabling and disabling application of the age restriction. When the control unit 21 receives the selection of “enabling" via the touch screen or the microphone, the control unit 21 saves the age restriction enabled to the non-volatile memory in S204. When the control unit 21 receives the selection of “disabling" via the touch screen or the microphone, the control unit 21 saves the age restriction disabled to the non-volatile memory in S204.

Any one of the above-described first to sixth examples may be applied, or any two or more of the first to sixth examples may be applied in combination as needed. Here, it is assumed that a combination of the first example, the fifth example, and the sixth example is applied.

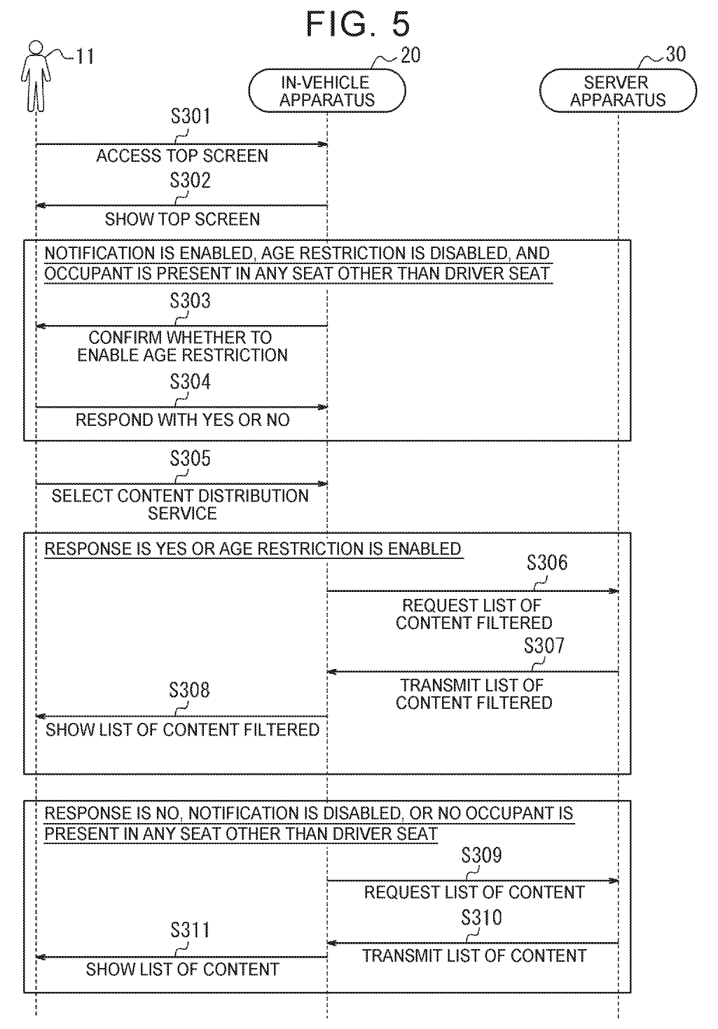

For example, as shown in FIG. 5, the user 11 is able to access a top screen in S301. The control unit 21 causes the display to show the top screen in S302.

When the control unit 21 determines that the notification enabled and the age restriction disabled are saved in the non-volatile memory and an occupant is present in any seat, other than the driver seat, of the vehicle 10 during the period from when the accessory power is turned on until accessing the top screen for the first time, the control unit 21 causes the display to show the confirmation screen or causes the speaker to output a question in S303. In other words, the control unit 21 confirms with the user 11 whether to consent to application of the age restriction. The user 11 is able to respond with Yes or No in S304. In other words, the user 11 is able to select any one of consent or refusal for application of the age restriction. In the case of Yes, that is, when consent is selected, the control unit 21 sets the exemption condition flag to False. On the other hand, in the case of No, that is, when refusal is selected, the control unit 21 sets the exemption condition flag to True.

When the age restriction enabled is saved in the non-volatile memory during the period from when the accessory power is turned on until accessing the top screen for the first time, the control unit 21 sets the exemption condition flag to False without going through S303 and S304. On the other hand, when the control unit 21 determines that the notification disabled and the age restriction disabled are saved in the non-volatile memory or no occupant is present in any seat, other than the driver seat, of the vehicle 10 during the period from when the accessory power is turned on until accessing the top screen for the first time, the control unit 21 sets the exemption condition flag to True without going through S303 and S304.

In this example, the exemption condition flag is set only during the period from when the accessory power is turned on until accessing the top screen for the first time. Alternatively, in another example, the exemption condition flag may be set each time accessing the top screen.

The control unit 21 saves the value of the exemption condition flag in a volatile memory, such as RAM. Alternatively, the control unit 21 may save the value of the exemption condition flag in the non-volatile memory and may initialize the value of the exemption condition flag when the accessory power is turned off or turned on again.

When the control unit 21 receives user input to select one of the plurality of content distribution services via the input device 12 in S106, the control unit 21 checks the value of the exemption condition flag in S107.

For example, as shown in FIG. 5, the user 11 is able to select a content distribution service by touching the top screen or using voice in S305. When the control unit 21 receives selection of a content distribution service via the touch screen or the microphone, the control unit 21 checks the value of the exemption condition flag saved in the volatile memory or the non-volatile memory.

When the value of the exemption condition flag is False, the control unit 21 uses the selected content distribution service by applying the set age restriction in S108. Specifically, the control unit 21 receives a list including only content not subject to the age restriction stored in the storage unit 22, via the communication unit 23 from the server apparatus 30 that provides the selected content distribution service. The control unit 21 outputs the received list via the output device 13.

For example, as shown in FIG. 5, in S306, the control unit 21 notifies the server apparatus 30 that provides the selected content distribution service, of the setting of the age restriction saved in non-volatile memory via the communication unit 23, and also requests a list of filtered content. The server apparatus 30 transmits a list of content filtered according to the setting of the age restriction in S307. In S308, the control unit 21 causes the display to show a list of content filtered according to the setting of the age restriction, transmitted from the server apparatus 30 via the communication unit 23.

When the value of the exemption condition flag is True, the control unit 21 uses the selected content distribution service without applying the set age restriction in S109. Specifically, the control unit 21 receives a list including not only content not subjected to the age restriction stored in the storage unit 22 but also other content via the communication unit 23 from the server apparatus 30 that provides the selected content distribution service. The control unit 21 outputs the received list via the output device 13.

For example, as shown in FIG. 5, in S309, the control unit 21 requests a list of content via the communication unit 23 from the server apparatus 30 that provides the selected content distribution service without notifying the server apparatus 30 of the set age restriction saved in the non-volatile memory. The server apparatus 30 transmits a list of content in S310. The control unit 21 causes the display to show the list of content transmitted from the server apparatus 30 via the communication unit 23 in S311.

When the control unit 21 receives user input to select one of the pieces of content included in the output list via the input device 12 in any of S108 and S109, the control unit 21 receives the selected piece of content via the communication unit 23 from the server apparatus 30 that provides the selected content distribution service. The control unit 21 outputs the received piece of content via the output device 13.

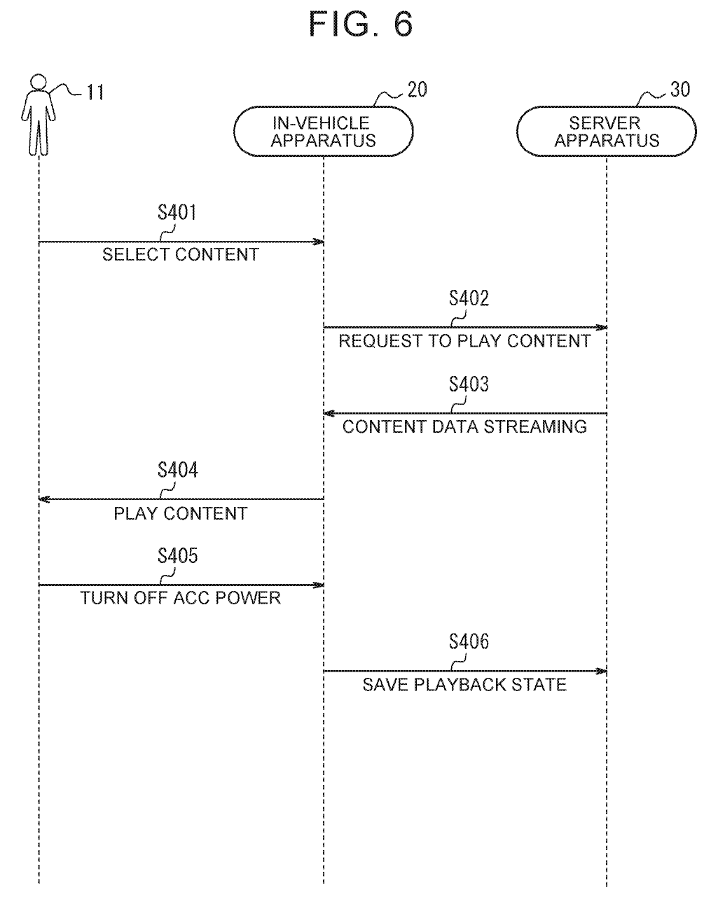

For example, as shown in FIG. 6, the user 11 is able to select content by touching the list of content shown on the display or using voice in S401. When the control unit 21 receives selection of content via the touch screen or the microphone, the control unit 21 issues a request via the communication unit 23 to the server apparatus 30 that provides the selected content distribution service to play the selected piece of content in S402. The server apparatus 30 starts streaming content data in S403. The control unit 21 causes the display, the speaker, or both to play the content transmitted from the server apparatus 30 in S404.

S106, S107, S108, S109, and S110 are repeated until the accessory power is turned off.

For example, as shown in FIG. 6, the user 11 is able to turn off the accessory power by performing an operation, such as pressing the power button of the vehicle 10, in S405. The control unit 21 causes the server apparatus 30 that provides the selected content distribution service to save the playback state of the content via the communication unit 23 in S406.

When the accessory power is turned off and then turned on again, S103 is executed again.

For example, it is assumed that the accessory power is turned off in S405 while the content is being played in S404. Since the playback state of the content is saved in S406, only the setting of the exemption condition flag may be performed when the accessory power is turned on again, and a subsequent portion of the content may be played without displaying a list of content.

When any one of the plurality of content distribution services is used without applying the age restriction and, after that, the same content distribution service is used with the age restriction applied, and when the previously output content is content not subject to the age restriction, the control unit 21 outputs a subsequent portion of the same content via the output device 13, and does not output the subsequent portion when the previously output content is not content not subject to the age restriction.

For example, it is assumed that S309, S310, and S311 are executed because the exemption condition flag is set to True and, after that, S401, S402, S403, S404, S405, and S406 are executed. When it is assumed that the exemption condition flag is set to False unlike the previous time at the time when the accessory power is turned on again, the same content is played in S404 when the content that was being played in the previous S404 is content not subject to the age restriction. On the other hand, when the content that was being played in the previous S404 is not content not subject to the age restriction, S306, S307, and S308 are executed and, after that, steps from S401 are executed as needed. In other words, when the previously output content is not content not subject to the age restriction, the control unit 21 outputs a list of only content not subject to the age restriction via the output device 13.

As described above, in the present embodiment, the communication unit 23 of the in-vehicle apparatus 20 communicates with one or more server apparatuses 30 that provide a plurality of content distribution services. When the control unit 21 of the in-vehicle apparatus 20 receives user input to set a single age restriction, the control unit 21 applies the set single age restriction when any one of the plurality of content distribution services is used via the communication unit 23 regardless of which content distribution service is used. Therefore, according to the present embodiment, it is possible to collectively set an age restriction for a plurality of content distribution services. For example, it is not necessary to perform viewing restriction settings with different UIs for respective video streaming services. As a result, the convenience of the user 11 improves.

In the present embodiment, when the control unit 21 determines that the exemption condition is satisfied, the control unit 21 does not apply the age restriction when any one of the plurality of content distribution services is used regardless of which content distribution service is used. Therefore, according to the present embodiment, it is possible to apply an age restriction to a plurality of content distribution services depending on a situation. As a result, the convenience of the user 11 further improves.

In the present embodiment, the control unit 21 confirms with the user 11 whether to consent to application of an age restriction before any one of the plurality of content distribution services is used. However, when the control unit 21 receives user input to set an age restriction along with user input to select application of the age restriction without confirmation, the control unit 21 applies the age restriction when any one of the plurality of content distribution services is used without confirming with the user 11 whether to consent to application of the age restriction. Therefore, according to the present embodiment, it is possible to apply an age restriction to a plurality of content distribution services depending on a request of the user 11. As a result, the convenience of the user 11 further improves.

In the present embodiment, it is possible to change the setting of the age restriction automatically or semi-automatically with confirmation of the user 11 depending on a situation in the vehicle 10 using the sensor 14. For example, when a video streaming service is used on an IVI terminal, it is possible to change content viewing restrictions with little effort based on whether the user 11 is driving with a child or driving without a child. In other words, it is possible to respond immediately to changes in situations, such as whether a child is present in the vehicle 10.

The disclosure is not limited to the above-described embodiment. For example, two or more blocks shown in the block diagram may be integrated or one block may be divided. Instead of executing two or more steps described in the flowchart in time sequence in accordance with the description, the steps may be executed in parallel or in different order in accordance with the processing capacity of an apparatus that executes the steps, or as needed. Modifications are possible without departing from the purport of the disclosure.

What is claimed is:

1. An in-vehicle apparatus installed in a vehicle, the in-vehicle apparatus comprising:
a storage unit;
a communication unit configured to communicate with a server apparatus configured to provide a plurality of content distribution services; and
a control unit configured to
when the control unit receives user input to set an age restriction via an input device mounted on the vehicle, store the set age restriction in the storage unit,
during a period from when accessory power of the vehicle is turned on until the accessory power is turned off, determine whether an exemption condition is satisfied, using a sensor mounted on the vehicle,
in response to receiving user input to select one of the content distribution services via the input device, receive a list including content not subject to the age restriction stored in the storage unit, via the communication unit from the server apparatus configured to provide the selected content distribution service when the control unit determines that the exemption condition is not satisfied, and receive a list including other content in addition to the content not subject to the age restriction when the control unit determines that the exemption condition is satisfied,
output the received list via an output device mounted on the vehicle,
in response to receiving user input to select one of pieces of content included in the list via the input device, receive the selected piece of content via the communication unit from the server apparatus configured to provide the selected content distribution service, and
output the received piece of content via the output device.

2. An in-vehicle apparatus installed in a vehicle, the in-vehicle apparatus comprising:
a communication unit configured to communicate with a server apparatus configured to provide a plurality of content distribution services; and
a control unit configured to, in response to receiving user input to set an age restriction, apply the set age restriction regardless of which content distribution service is used when one of the content distribution services is used via the communication unit.

3. The in-vehicle apparatus according to claim 2, wherein the control unit is configured to
in response to receiving user input to select one of the content distribution services, receive a list of only content not subject to the age restriction, via the communication unit from the server apparatus configured to provide the selected content distribution service, and
output the received list via an output device mounted on the vehicle.

4. The in-vehicle apparatus according to claim 3, wherein the control unit is configured to
in response to receiving user input to select one of pieces of content included in the list, receive the selected content via the communication unit from the server apparatus configured to provide the selected content distribution service, and
output the received piece of content via the output device.

5. The in-vehicle apparatus according to claim 2, wherein the control unit is configured to not apply the age restriction when the control unit determines that an exemption condition is satisfied, and one of the content distribution services is used regardless of which content distribution service is used.

6. The in-vehicle apparatus according to claim 5, wherein the control unit is configured to
output a subsequent portion of the same content via an output device mounted on the vehicle when the same content distribution service is used with the age restriction applied, and previously output content is content not subject to the age restriction after one of the content distribution services is used without applying the age restriction, and
not output the subsequent portion when the previously output content is not content not subject to the age restriction.

7. The in-vehicle apparatus according to claim 6, wherein the control unit is configured to, when the previously output content is not content not subject to the age restriction, output a list of content not subject to the age restriction, via the output device.

8. The in-vehicle apparatus according to claim 5, wherein:
the exemption condition includes a condition that no occupant is present in any seat, other than a driver seat, of the vehicle; and
the control unit is configured to determine whether an occupant is present in any seat, other than the driver seat, of the vehicle using a sensor mounted on the vehicle.

9. The in-vehicle apparatus according to claim 5, wherein:
the exemption condition includes a condition that no child is present in the vehicle; and
the control unit is configured to determine whether a child is present in the vehicle, using a sensor mounted on the vehicle.

10. The in-vehicle apparatus according to claim 5, wherein:
the exemption condition includes a condition that no occupant below the age restriction is present in the vehicle; and
the control unit is configured to determine whether an occupant below the age restriction is present in the vehicle, using a sensor mounted on the vehicle.

11. The in-vehicle apparatus according to claim 5, wherein:
the exemption condition includes a condition that no occupant registered as being subject to the age restriction is present in the vehicle; and
the control unit is configured to determine whether an occupant registered as being subject to the age restriction is present in the vehicle, using a sensor mounted on the vehicle.

12. The in-vehicle apparatus according to claim 5, wherein:
the exemption condition includes a condition that a user does not consent to application of the age restriction; and
the control unit is configured to, before one of the content distribution services is used, confirm with the user whether to consent to application of the age restriction, using an input device and an output device mounted on the vehicle.

13. The in-vehicle apparatus according to claim 12, wherein the control unit is configured to, in response to receiving user input to set the age restriction along with user input to apply the age restriction without confirmation, apply the age restriction when one of the content distribution services is used without confirming with the user whether to consent to application of the age restriction.

14. The in-vehicle apparatus according to claim 5, wherein:
the exemption condition includes a condition that a user selects not to apply the age restriction; and
the control unit is configured to receive user input to set the age restriction along with user input to select not to apply the age restriction.

15. The in-vehicle apparatus according to claim 5, wherein the control unit is configured to, during a period from when accessory power of the vehicle is turned on until the accessory power is turned off, determine whether the exemption condition is satisfied.

16. The in-vehicle apparatus according to claim 2, wherein the control unit is configured to
estimate an age of an occupant in the vehicle, and
instead of receiving user input to set the age restriction, automatically set the age restriction based on the estimated age.

17. The in-vehicle apparatus according to claim 2, wherein the content distribution services include a video streaming service.

18. A vehicle comprising the in-vehicle apparatus according to claim 2.

19. An age restriction application method comprising applying an age restriction regardless of which content distribution service is used when an in-vehicle apparatus configured to communicate with one or more server apparatuses configured to provide a plurality of content distribution services receives user input to set the age restriction, and one of the plurality of content distribution services is used.

20. A non-transitory storage medium storing instructions executable on one or more processors and causing the one or more processors to execute the age restriction application method according to claim 19.
